(19) United States
(12) Patent Application Publication
(10) Pub. No.: US 2026/0131230 A1
(43) Pub. Date: May 14, 2026

(54) PUZZLE

(71) Applicant: LOVEVERY, INC., Boise, ID (US)

(72) Inventors: Katlyn Elizabeth Morris, Boise, ID (US); Philip Jacob Fouts, Boise, ID (US)

(21) Appl. No.: 19/481,307

(22) PCT Filed: Dec. 11, 2023
(86) PCT No.: PCT/US2023/083384

§ 371 Date: Nov. 4, 2025

Related U.S. Application Data
(60) Provisional application No. 63/500,128, filed on May 4, 2023.

(51) Int. Cl. A63F 9/10; G09B 1/36

(52) U.S. Cl. CPC A63F 9/10; G09B 1/36

(57) ABSTRACT

A children's puzzle including a plurality of pieces (104, 106, 108) that when connected together form a set of rings. Each piece has a distal end (312) and a proximal end (302) that are respectively and selectively interlockable with proximal and distal ends of any other piece in the plurality of pieces. Each end features a mirrored recess and projection, such that the ends of adjacent pieces can be connected in either of two orientations. The pieces of a given ring carry respective graphics that share a conceptual attribute, such as representing members of a shared classification of objects or of names that rhyme.

### TECHNICAL FIELD

This invention relates to puzzles, and more particularly to developmental puzzles for children.

### BACKGROUND

Puzzles vary in complexity and difficulty. People of all ages, from children to elderly attempt to complete puzzles. For young children, working on completing puzzles develops cognitive abilities, problem solving skills, and pattern and color recognition capabilities. Working on puzzles can also be a fun and enjoyable experience. New and improved types of puzzles are always sought.

### SUMMARY

The details of one or more embodiments of the invention are set forth in the accompanying drawings and the description below. Other features, objects, and advantages of the invention will be apparent from the description and drawings, and from the claims. The present disclosure relates to a children's puzzle. The puzzle includes multiple interlockable pieces that when connected together, form a set of closed-path shapes such as rings. A child can create the rings by connecting the pieces that have conceptually similar graphics on them.

Implementations of the present disclosure include a children's puzzle including a plurality of curved pieces of identical shape that when connected together end to end, form a set of rings of equal numbers of pieces. Each piece has two ends. Each end defines a profile that includes both a projection and a recess. The profile of one of the two ends mirroring the profile of the other of the two ends about a center of the end, such that any two pieces may be interconnected in each of two orientations: one orientation in which the two pieces curve in the same direction and the other orientation in which the two pieces curve in opposite directions. Each piece has a front face and a back face opposite the front face. The front faces of the pieces bearing different graphics. The graphics of the front faces of the pieces forming multiple sets of graphics in which the illustrations of any one of the sets of graphics share a common conceptual aspect. The conceptual aspect shared by the graphics of any one set is different from the conceptual aspect shared by the graphics of any other set, such that the pieces bearing graphics of any one set are connectable to form together a single ring.

In some implementations, each back face includes a respective color or pattern such that in any ring of conceptually similar pieces no two pieces have the same color or pattern. In some examples, at least two pieces in the puzzle have back faces with the same color or pattern. The puzzle may have a finite number of variations for the colors or patterns on the back faces of the pieces, the finite number being the same as the number pieces connectable to form a ring.

In some implementations, all pieces in the plurality of curved pieces are geometrically identical.

In some implementations, a common conceptual aspect in a set is rhyming names that the graphics of the set convey. In some implementations, a common conceptual aspect in a set is a common biological class conveyed by the graphics of the set, the biological class being one of mammals, insects, amphibians, birds, aquatic animals, plants, or non-living objects. In some implementations, a common conceptual aspect in a set is members classifiable in a group, the group being selected from foods, toys, or vehicles.

In some implementations, the number of pieces in all rings is the same.

The rings can be circular or can be oval.

In some implementations, the pieces can further be connectable to form part of a track. The track can have at least one open ending.

In some implementations, the respective graphic on each piece is unique to that piece and not repeated on any other piece.

### DESCRIPTION OF DRAWINGS

FIG. 1A shows the front view of an example puzzle ring, according to implementations of the present disclosure.

FIG. 1B shows the back view of the example ring shown in FIG. 1A.

FIG. 1C shows back view of separate puzzle pieces.

FIGS. 2A-2C show front views of more example puzzle rings formed by connecting multiple puzzle pieces.

FIG. 3 is a perspective view of an example puzzle piece.

FIGS. 4A and 4B show two alternate arrangements of two interlocking puzzle pieces.

FIG. 5 shows an example track formed by interlocking puzzle pieces.

Like reference symbols in the various drawings indicate like elements.

### DETAILED DESCRIPTION

While a number of examples have been described for illustration purposes, the foregoing description is not intended to limit the scope of the invention, which is defined by the scope of the appended claims. There are and will be other examples and modifications within the scope of the following claims.

A puzzle is a toy or game designed to challenge a person's cognitive abilities and problem solving skills. A puzzle can include multiple pieces that when connected together, convey a particular or meaningful concept. The puzzle pieces according to the present disclosure include respective graphics, and can be connected together to form a set of closed-ended geometric shapes, e.g., rings, such that the pieces in each ring have conceptually similar or related graphics.

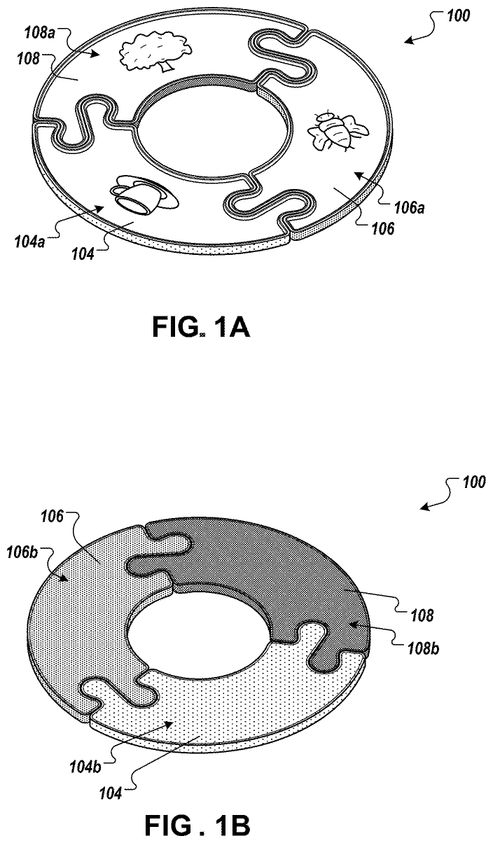

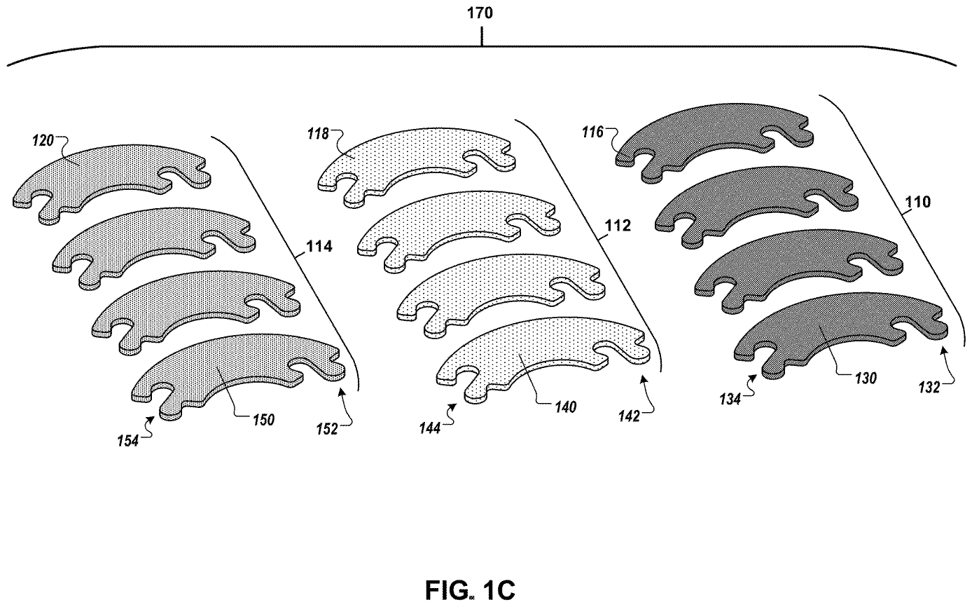

FIG. 1A illustrates the front view of an example puzzle ring 100 formed by interlocking three curved puzzle pieces 104, 106, and 108. FIG. 1B shows the back view of the same ring 100. FIG. 1C shows back view of separate puzzle pieces.

Each puzzle piece has a respective graphic illustrated on at least one side of the piece. In the example ring shown in FIG. 1A, the puzzle pieces have respective graphics of a bee, a tree, and a cup of tea on respective front (or top) faces 104a, 106a, 108a of the pieces.

When playing, a child forms a ring by selecting and connecting puzzle pieces that have coordinated graphics. Coordinated graphics are graphics that share a common conceptual aspect. For example, the graphics on the ring shown in FIG. 1A are coordinated graphics because they have rhyming names: tree, bee, and tea. In another example, graphics of a ring can show living matters that are classified in the same group, such as mammals, insects, amphibians, birds, aquatic animals, plants, etc. In another example, a ring can include graphics of a group of objects, foods, toys, vehicle, etc. that are somehow conceptually related to each other. For example, wheels, headlights and windshield wipers are all elements of a car. A child may form a ring by connecting these pieces to each other to convey elements of a car.

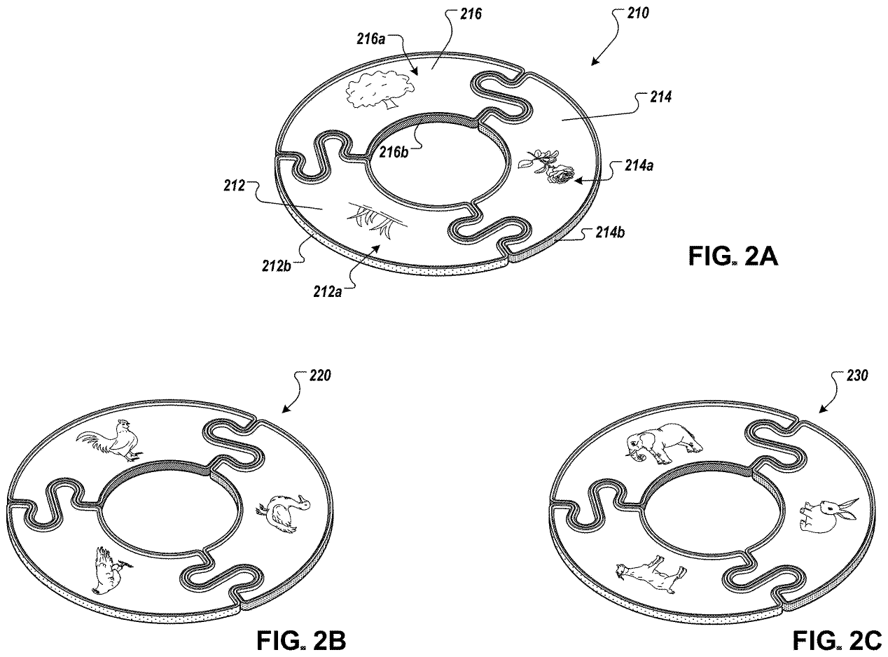

FIGS. 2A-2C illustrate front view of further example rings 200, 210, and 220. Ring 210, for example, is formed by puzzle pieces 212, 214, and 216. Puzzle piece 212 has a graphic of grass on its front face 212a, puzzle piece 214 has a graphic of a flower on its front face 214a, and puzzle piece 216 has a graphic of a tree on its front face 216a. The pieces of ring 210 have coordinated graphics because they contain illustrations relating to plants. Pieces of ring 200 have coordinated graphics because they have respective graphics of mammals: a goat, an elephant, and a rabbit. Pieces of ring 220 have coordinated graphics because they have graphics of birds: an eagle, a duck, and a rooster.

The graphics can be presented on planar surfaces of the pieces. For example, in FIG. 2A, the graphics are illustrated on planar surfaces of front faces 212a, 214a, 216a of respective pieces 212, 214, and 216.

The respective graphic on each piece may be a unique graphic specific to that piece and not repeated on any other piece. In some implementations, one or two pieces can share similar or the same graphics. For example, a piece with a graphic of a tree can be repeated twice to be included in the rhyming ring shown in FIG. 1A, as well as in the plant ring 210 shown in FIG. 2A.

Each puzzle piece has a top surface and a bottom surface opposite the top surface. The top surface forms the front face, and the bottom surface forms the back face of the piece. For example, the pieces in the rhyming ring shown in FIGS. 1A and 1B have respective front faces 104a, 106a, and 108a on their top surfaces, and respective back faces 104b, 106b, and 108b on their bottom surface. Consequently, back face 104b is opposite front face 104a, back face 106b is opposite front face 106a, and back face 108b is opposite front face 108b on the respective pieces.

Instead of illustrations, the back surfaces have respective patterns or colors presented on them. FIG. 1C shows a set 170 of curved puzzle pieces divided into three subsets 110, 112, and 114, where the patterns or colors on the back faces (i.e., the depicted surface) of the pieces in each subset is different from the patterns or colors on the back face of the other two subsets.

In one example, all of the pieces that are related by their front graphics have similar patterns or colors on their respective back surfaces. For example, pieces 130 and 116 in FIG. 1C have the same patterns, as do pieces 140 and 118, and pieces 150 and 120. In another example, which may stimulate further cognitive development, all of the pieces that are related by their front graphics have different patterns or colors on their respective back surfaces, such as in the three pieces that make up ring 100 of FIGS. 1A and 1B. For example, piece 106 in FIG. 1B has a pattern or color on its back face 106b that is different from the patterns of colors on either of back faces 104b and 108b of respective pieces 104 and 108 pieces. As another example, in FIG. 2A, each of the back faces 212b, 214b, and 216b of respective pieces 212, 214, and 216 has a different color of pattern from the other two back faces of the pieces in ring 210.

In some implementations, the puzzle has a finite number of variations for the colors or patterns on the back surfaces, and the finite number is the same as the number of pieces used to form a ring. For example, in FIG. 1 a ring is formed by three pieces, and three sets of color or patterns (110, 112, and 114) are provided for the rings.

While FIGS. 1 and 2 show example implementations where the pieces are connectable to form a ring, other implementations can be designed to form other closed-ended geometric shapes such as triangles, squares, etc. For example, each piece can form a side of a closed-ended geometric shape (such as a triangle, square), with the interlocking endings forming the corners of the closed-ended geometric shape when the pieces are connected together.

A ring can be circular or oval. While the examples shown in FIGS. 1 and 2 show rings formed from three pieces, other implementations can be designed to form a ring or other closed-ended geometric shapes with any other number of puzzle pieces, e.g., four pieces, five pieces, etc. In some implementations, the number of pieces in all rings (or in all of the closed-ended geometric shapes) is the same. For example, each ring shown in FIG. 2 has only three respective pieces.

In some implementations, such as the one shown in FIG. 1C, each puzzle piece has more than one interlockable end and can be connected to other pieces from multiple ends. For example, piece 130 can be connected to other pieces from either of the two interlockable ends 132 and 134. For example, proximal interlockable end 134 can be connected to distal interlockable end 142 of piece 140, and distal interlockable end 132 is connectable to proximal interlockable end 154 of piece 150.

In some implementations, all pieces of the puzzle have identical interlockable ends and can interchangeably connect to each other from multiple ends. For example, pieces 130 and 140 in FIG. 1C have identical proximal interlockable ends 132, 142, as well as identical distal interlockable ends 134, 144. Thus, piece 130 can be connected to piece 140 either from proximal end 132 by interlocking to distal end 144, or from distal end 134 by interlocking to proximal end 142. Preferably, all pieces of the puzzle have identical interlockable end geometries, and each piece can be interlockably connected to any other piece of the puzzle. In some implementations, all pieces of the puzzle have the same shapeand size.

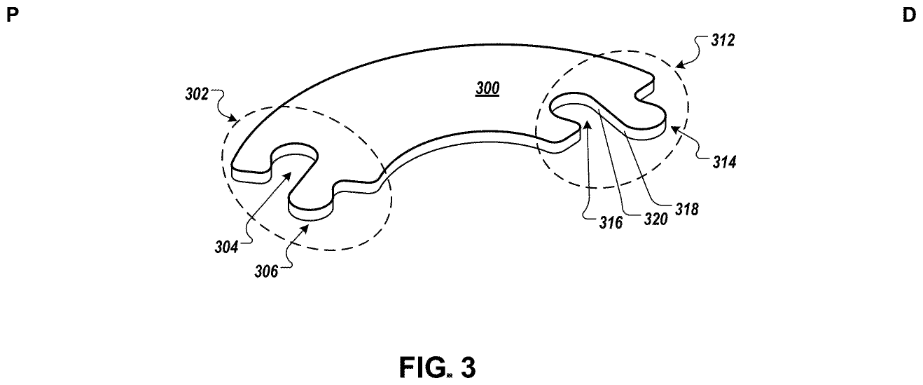

FIG. 3 shows an example curved puzzle piece 300. Puzzle piece 300 has two ends: proximal end 302 and distal end 312, which are pointed out by dashed lines. Proximal end 302 has a first profile including a recess 304 and a projection 306. Distal end 312 has a second profile including a recess 316 and a projection 314. Proximal direction is indicated with letter “P”, and distal direction is indicated by letter “D” in FIG. 3.

Each projection has one side surface that continuous to be a side surface of the adjacent recess on the same end. For example, projection 314 has a side surface 318 that continues to side surface 320 of recess 316 on the distal end 312.

The first profile of proximal end 302 is an inverse (or mirror) of the second profile of distal end 312. Particularly, the size and geometry of projection 306 in the proximal end 302 are the same as the size and geometry of projection 314 in the distal end 312, and the size and geometry of recess 304 in the proximal end are the same as the size and geometry of recess 316 in the distal end 312.

Further, the first profile of the proximal end 302 is a complementary of the second profile of the distal end 312. In other words, if the distal end 312 is cut (for example along the dashed line) from the puzzle piece 300 and attached to the proximal end 302, the two ends would interlock. The interlock would be formed by projection 314 of the distal end 312 fitting into recess 304 of the proximal end 302, and projection 306 of the proximal end 302 fitting into recess 316 of the distal end 312.

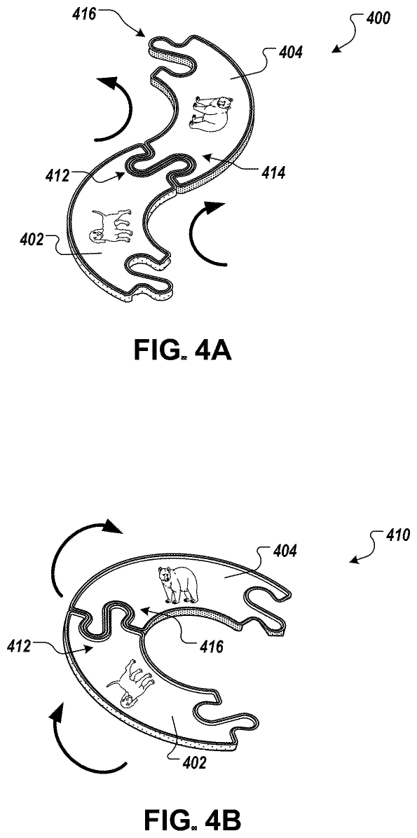

Because of the identical and inverse profiles of the ends, two pieces can be connected together at either of their ends, and thus, form two orientations: one orientation in which the two pieces curve in the same direction (i.e., a curvature-complying configuration) and the other orientation in which the two pieces curve in opposite directions (i.e., a curvature-reversing configuration). FIGS. 4A and 4B show two puzzle pieces being interlockably connected in two orientation. In FIG. 4A, distal end 414 of puzzle piece 404 is interlocked into distal end 412 of puzzle piece 402, forming a curvature-reversing configuration 400. In FIG. 4B, proximal end 416 of puzzle piece 404 is interlocked into distal end 412 of puzzle piece 402, forming a curvature-complying configuration 410.

Another unique feature that the end profiles provide is that because of the reverse ends on each piece, two puzzle pieces are connectable only if the front faces (that bears a graphic) of both pieces are directed in the same direction, e.g., both directed upward or both directed downward. In other words, an upwardly facing front face of a piece cannot be connected to an upwardly facing back face of another piece. Thus, if piece 404 in FIG. 4A is flipped to become a back face upwardly directed piece, piece 404 can no longer be interlocked to the front face upwardly directed piece 402. This feature provides further complexity that can help enhanced cognitive and spatial perception development.

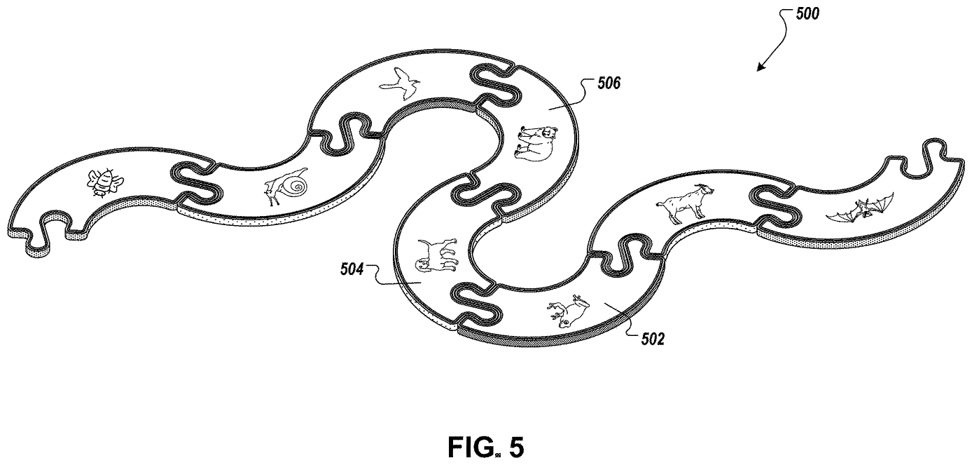

In addition to forming a closed-ended geometric shape, the pieces may be connected together to form a track. The track can be open-ended. FIG. 5 shows an example track 500 formed from connecting multiple puzzle pieces, e.g., pieces 502, 504, 506. Path 500 includes several curvature-reversing and curvature-complying sections. For example, the connection between pieces 502 and 504 forms a curvature-complying section, and the connection between pieces 504 and 506 forms a curvature-reversing section.

1. A children puzzle comprising a set of curved pieces of identical shape that when connected together end to end, form a set of rings of equal numbers of pieces,
wherein each piece has two ends, each end defining a profile that includes both a projection and a recess, the profile of one of the two ends mirroring the profile of the other of the two ends about a center of the end, such that any two pieces may be interconnected in each of two orientations: one orientation in which the two pieces curve in the same direction and the other orientation in which the two pieces curve in opposite directions;
wherein each piece has a front face and a back face opposite the front face, the front faces of the pieces bearing different graphics, the graphics of the front faces of the pieces forming multiple sets of graphics in which the illustrations of any one of the sets of graphics share a common conceptual aspect, and the conceptual aspect shared by the graphics of any one set is different from the conceptual aspect shared by the graphics of any other set, such that the pieces bearing graphics of any one set are connectable to form together a single ring.

2. The children puzzle of claim 1, wherein each back face includes a respective color or pattern, such that in any ring of pieces with graphics of conceptually similar aspect, no two pieces have the same color or pattern.

3. The children puzzle of claim 2, wherein at least two pieces in the puzzle have back faces with the same color or pattern.

4. The children puzzle of claim 2, wherein the puzzle has a finite number of variations for the colors or patterns on the back faces of the pieces, the finite number being the same as the number of pieces connectable to form a ring.

5. The children puzzle of claim 1, wherein all pieces in the set of curved pieces are geometrically identical.

6. The children puzzle of claim 1, wherein the conceptual aspect shared by the graphics of one of the sets of graphics is a rhyming of words conveyed by the graphics of the set of graphics.

7. The children puzzle of claim 1, wherein the conceptual aspect shared by the graphics of one of the sets of graphics is a common biological class conveyed by the graphics of the set, the biological class being of the group of biological classes consisting of mammals, insects, amphibians, birds, aquatic animals and plants.

8. The children puzzle of claim 1, wherein the conceptual aspect shared by the graphics of one of the sets of graphics is a classification of a group consisting of foods, toys, and vehicles.

9. The children puzzle of claim 1, wherein the rings are circular.

10. The children puzzle of claim 1, wherein the rings are oval.

11. The children puzzle of claim 1, wherein the curved pieces are connectable to form part of an open-ended track.

12. The children puzzle of claim 1, wherein the respective graphic on each curved piece is unique to that piece and not repeated on any other piece.
